(19) United States
(12) Patent Application Publication
(10) Pub. No.: US 2018/0355590 A1
(43) Pub. Date: Dec. 13, 2018

(54) Device for Connecting at Least One Tap and a Pipe with Thermal Decoupling

(71) Applicant: Viega Technology GmbH & Co. KG, Attendorn (DE)

(72) Inventors: Tobias Klosta, Siegen (DE); Sudi Sinoplu, Attendorn (DE); Werner Schulte, Lennestadt (DE)

(21) Appl. No.: 15/781,855

(22) PCT Filed: Oct. 25, 2016
(86) PCT No.: PCT/EP2016/075652

§ 371 Date: Jun. 6, 2018

(30) Foreign Application Priority Data
Dec. 14, 2015 (DE) 10 2015 121 696.5

(51) Int. Cl. E03C 1/04; F16L 41/02; F16L 59/14

(52) U.S. Cl. CPC E03C 1/0403; E03C 1/041; F16L 59/14; F16L 41/023; F16L 41/021

(57) ABSTRACT

A device for connecting at least one fitting and a pipe includes at least one inlet, at least one outlet, at least one connection and an inner channel which connects the inlet and the outlet in a through-flowing manner, a drainage channel being provided, which connects the inner channel to the connection in a through-flowing manner. The device connects at least one fitting and a pipe, by means of which the fitting is protected and hygiene conditions improved. To this end, the drainage channel includes at least one section for thermal decoupling of the inner channel and the connection. Further disclosed is a system including at least one device described above.

The invention relates to a device for connecting at least one tap and a pipe, having at least one inlet, having at least one outlet, having at least one connection and having an inner channel which connects the inlet and the outlet so as to be able to be flowed through, wherein there is provided a drain which connects the inner channel to the connection so as to be able to be flowed through. The invention further relates to a system having at least one device according to the invention.

In particular in the domestic installation of drinking water or heating pipes, devices of the type mentioned in the introduction are used in order to provide a branching from a pipeline for the connection of a tap. In systems with cold water pipes and hot water pipes and taps which are connected thereto and which, for example, are used to remove water from the pipes at sink basins, showers or bath tubs, heat is transferred between the taps and the pipes. In this instance, the tap is heated by the hot water pipe which is connected thereto or cooled by the cold water pipe. In particular when circulation pipes are used, this effect is increasingly evident since, in this instance, the hot water pipes have a constantly high or low temperature and heat is transmitted to the tap or from the tap.

As a result of the heat transfer, however, the taps may become damaged and the service-life thereof may be shortened. This is particularly the case with mixer taps which, as a result of being simultaneously connected to a hot water pipe and a cold water pipe, are subjected to a temperature gradient.

Furthermore, hygiene problems may also occur in such systems. For example, heat is transferred indirectly via the tap from the hot water pipe to the cold water pipe, whereby the temperature in the cold water pipe may exceed permissible limit values with respect to the formation of germs.

The object of the invention is to provide a device for connecting at least one tap and a pipe and a system for this by means of which the tap is protected and the hygiene conditions are improved.

This object relating to a device is achieved in that the drain has at least one portion for thermal decoupling from the inner channel and connection.

The heat transfer between the pipe which can be connected to the inlet or the outlet of the device and the tap which can be connected to the connection is carried out partially by the material of the device itself. As a result of the fact that the drain has at least one portion for thermal decoupling, this heat transfer is reduced.

Consequently, with a hot water pipe there is significantly less heating of the tap and with a cold water pipe significantly less cooling of the tap. Consequently, a connected tap is protected and hygiene problems can be combatted.

The device may in this instance be constructed as a wall plate or dual wall plate and in particular have means for securing in or on a wall. The connection is suitable for connecting a tap and has, for example, an inner thread or outer thread. The inlet and outlet may also have means for connecting to pipe elements, for example, inner thread, outer thread or fittings, such as press fittings.

It is conceivable for the portion for thermal decoupling to be actively cooled or heated.

In a first embodiment of the device, the portion for thermal decoupling has a lower thermal conductivity than the remaining drain and/or the inner channel. The portion of the device which forms the inner channel and the remaining portions of the drain may, for example, substantially comprise metal, in particular red brass or copper. In particular, the inner channel and in particular at least a portion of the drain are then constructed as a cast component or rotary component. Metals such as red brass or copper have a comparatively high thermal conductivity.

If the portion for thermal decupling has a material with a lower thermal conductivity, the heat transfer is effectively reduced along the drain.

In an embodiment of the device, the portion for thermal decoupling comprises at least partially high-grade steel, plastics material and/or ceramic material. These materials have, for example, in comparison with red brass or copper a lower thermal conductivity. In addition, these materials may also be suitable for drinking water applications and consequently ensure a wide application range of the device. It is possible to use as plastics materials in particular polybutylene terephthalate (PBT), polyoxymethylene (POM), polyamide (PA), polyethylene terephthalate (PET) or poylsulfone. Generally, thermoplastic plastics materials with good strength properties and high temperature resistance in reinforced and non-reinforced configurations can be used.

The portion for thermal decoupling may also have Teflon which may in particular also be used for sealing the transition of the portion for thermal decoupling to the remaining drain. Teflon also has a low thermal conductivity.

The portion for thermal decoupling may in particular be formed by a sleeve. The device can thereby be produced in a simple manner. The sleeve is, for example, screwed to the remaining drain by means of an inner thread or outer thread. The sleeve may further have an outer profile, for example, a hexagon, in order to facilitate the assembly.

According to another embodiment of the device, the portion for thermal decoupling along the drain has a length which corresponds to at least half of a diameter of the inner channel. Preferably, the length corresponds to at least the diameter of the inner channel. As a result of the use of a correspondingly long portion for thermal decoupling, the heat conductivity of the drain is further reduced, wherein the mentioned minimum length forms a good compromise between thermal decoupling and the most compact and stable geometry possible. 5 times, in particular 2 times the diameter of the inner channel may be provided as the maximum length.

Generally, a plurality of portions for thermal decoupling may also be provided, wherein the overall length, that is to say, the total of the lengths of the respective portions, may be decisive.

It is further conceivable to determine specific minimum lengths and maximum lengths of the portion for thermal decoupling using the wall thickness or the material of the drain.

According to another embodiment of the device, a means for decoupling the inner channel and drain in technical flow terms is provided. In addition to the thermal coupling already described above via the drain itself, when the device is used heat is also transmitted via the water flowing in the device. Means for decoupling the inner channel and drain in technical flow terms can reduce the water exchange between the inner channel and the drain and thereby combat this heat transfer.

Means for decoupling the inner channel and drain in technical flow terms may also be provided independently of the above-described portion for thermal decoupling. In a preferred embodiment of the device, however, the means for decoupling in technical flow terms is advantageously combined with at least one portion for thermal decoupling. It has been found that, as a result of this combination, a particularly effective suppression of the heat transfer between a connected tap and the pipe or the inner channel can be brought about.

The means for decoupling in technical flow terms comprises, for example, a backflow prevention means or a backflow valve which enables only a water flow from the inner channel into the drain when the tap is used and prevents a backflow. Alternatively or additionally, plates or guiding plates may be provided in the inner channel and/or in the drain and ensure improved flowability inside the inner channel and at the same time reduce the water exchange with the drain.

In an embodiment of the device, the surfaces of the inner channel and drain have different roughnesses as means for decoupling in technical flow terms. A flow within the inner channel can thereby also be promoted and an exchange with the drain can be reduced. It is possible in this instance for the surfaces of the inner channel and drain to be roughened to different extents by means of the production thereof, for example, in a casting operation. A mechanical or chemical roughening may also be provided or one or more surface coatings may also be applied.

In another embodiment of the device, the means for decoupling in technical flow terms comprises a curved piece. Using a curved piece, a technical flow effect can also be brought about in a simple manner and promotes a flow inside the inner channel and reduces an exchange with the drain.

In particular, the inner channel may extend approximately in a plane. The inner channel may be constructed in a straight manner. In particular, however, the inner channel extends in a curved manner. For example, the inner channel describes a U-shape so that the inlet and outlet are located in particular substantially parallel with each other, that is to say, connected lines have an angle of from 150° to 210° with respect to each other. Favourable flow conditions can thereby be brought about inside the inner channel. The curved piece may guide the drain out of the plane in which the inner channel extends. Consequently, a water exchange between the inner channel and the drain is prevented.

The curved piece may in particular provide an angle of more than 45°, preferably more than 70°. Preferably, the angle of the curved piece is between 70° and 110° so that the device enables a tap to be fitted at a substantially right angle with respect to a pipe.

In another embodiment of the device, the curved piece is arranged between the portion for thermal decoupling and the connection. Better decoupling and a more compact structure can thereby be achieved.

According to another embodiment of the device, the drain from the inner channel to the connection has a length which corresponds to at least 3 times a diameter of the inner channel, preferably at least 5 times the diameter of the inner channel. With a corresponding minimum length of the drain, an advantageous means for decoupling the inner channel and the drain in technical flow terms can already be provided since the flow resistance also increases with the length of the drain.

In order to ensure a compact geometry and an adequate water flow to the tap, however, the length of the drain from the inner channel to the connection corresponds in particular to a maximum of 15 times the diameter of the inner channel, preferably a maximum of 10 times the diameter of the inner channel.

According to another embodiment of the device, the drain has a cross-section which is a maximum of 90%, preferably a maximum of 75% of the cross-section of the inner channel. As a result of a reduction of the cross-section of the drain in comparison with the inner channel, the flow resistance in the drain is also increased and a mixing of the water in the inner channel with the water in the drain is reduced.

It is further conceivable to determine specific minimum lengths and maximum lengths of the drain using the wall thickness or the material of the drain.

According to another teaching, the above-mentioned objective is achieved with a system having at least one device described above and having at least one pipe which is connected to the inlet and the outlet and which extends partially through the inner channel. In particular the system is a drinking water system. The pipe is in particular configured as a circulation pipe.

In particular, at least one tap which is connected to the connection is provided.

As described above, when the device is used in a system, for example, together with a hot water pipe, significantly lesser heating of the tap occurs and with a cold water pipe a significantly lesser cooling of the tap occurs. Consequently, the tap is protected and hygiene problems can be combatted.

In an embodiment of the system, at least one cold water pipe and at least one hot water pipe are provided and at least one mixing tap for hot water and cold water is connected via the device to the cold water pipe and the hot water pipe. Particularly with mixing taps for cold water and hot water, there may occur in the tap large temperature gradients which shorten the service-life of the tap. As a result of the device described above, such problems can be reduced.

According to another teaching, the above-mentioned objective is achieved with a use of the device described above in a water system for connecting at least one tap and at least one pipe.

With regard to other advantages and embodiments of the system and the use, reference may be made to the above statements relating to the device. In addition, reference may be made to the following description of the drawings. In the drawings:

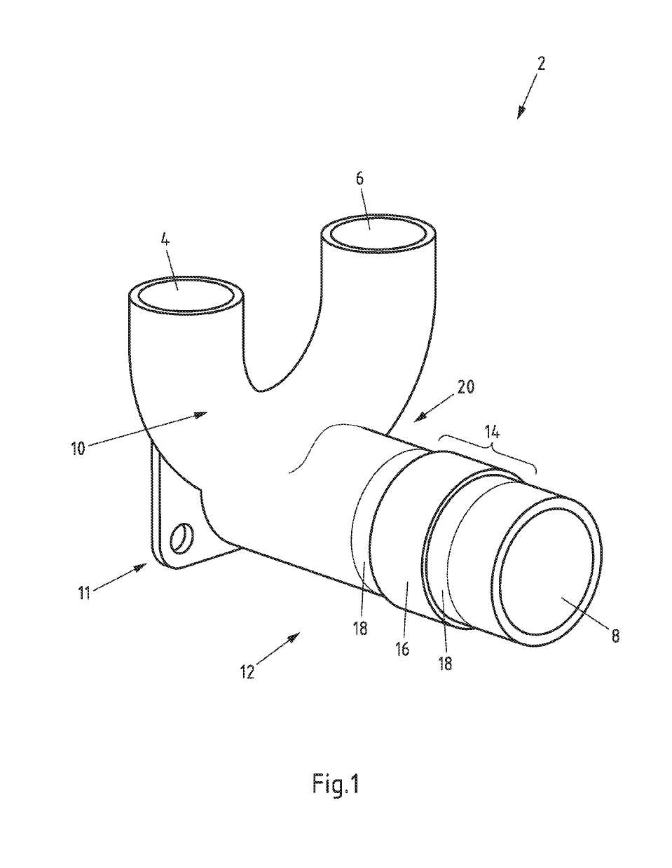

FIG. 1 shows a first embodiment of a device in a perspective view,

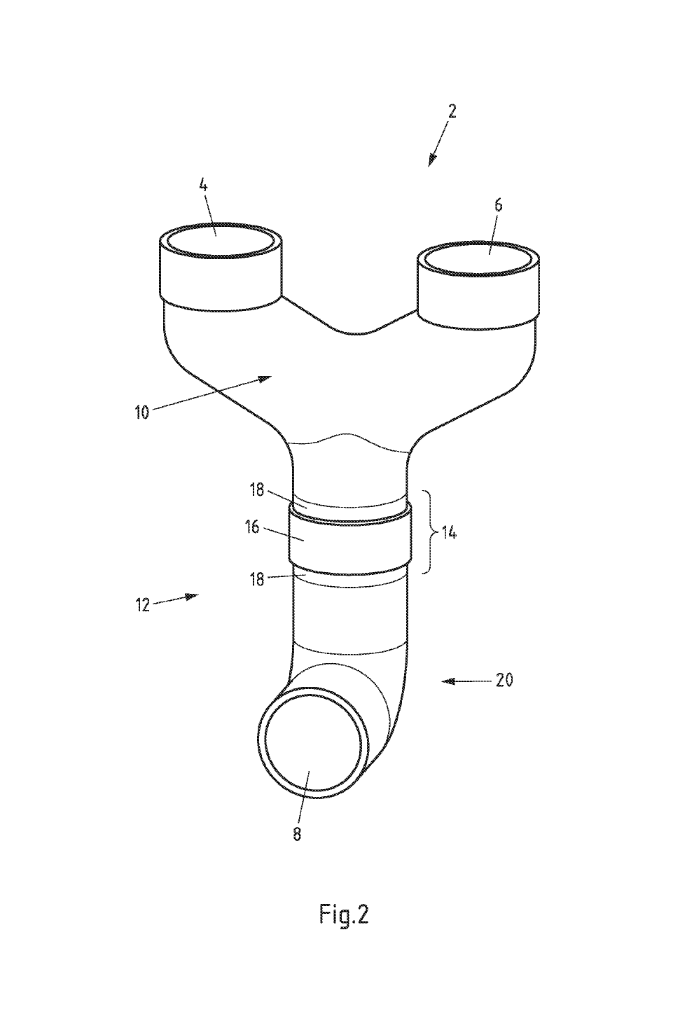

FIG. 2 shows a second embodiment of a device in a perspective view, and

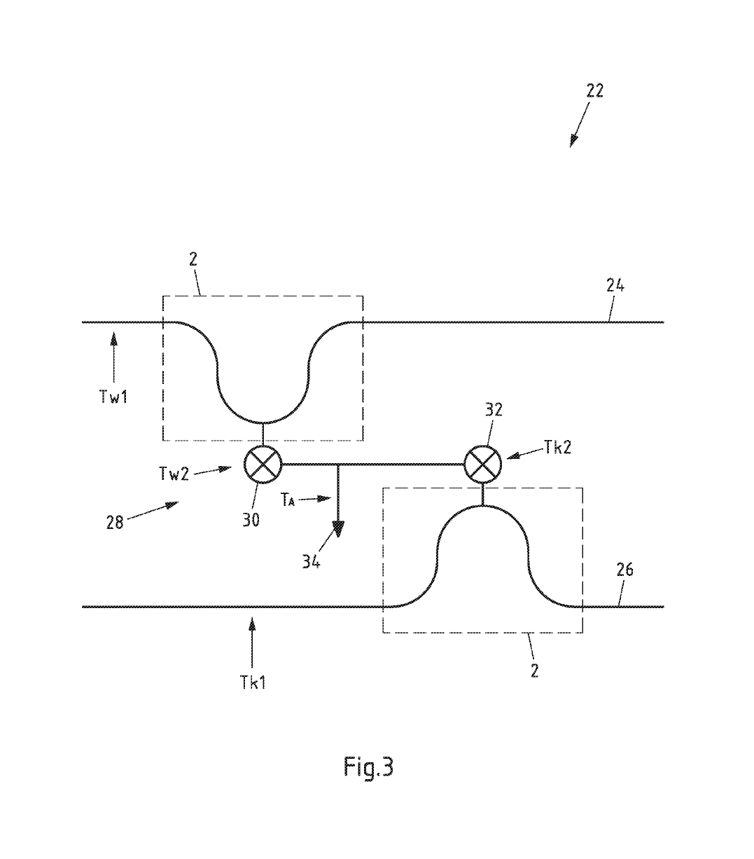

FIG. 3 shows an embodiment of a system as a schematic illustration.

FIG. 1 shows a first embodiment of a device 2 in a perspective view. The device 2 has an inlet 4 and an outlet 6 and a connection 8. The connection 8 is configured for the connection of a tap (not shown) and has, for example, an inner thread or an outer thread. The inlet 4 and outlet 6 may also have means for connection to pipe elements (not shown), for example, inner thread, outer thread, or fittings, such as press fittings.

The device 2 has an inner channel 10 which connects the inlet 4 and outlet 6 so as to allow flow. There is provided a U-piece of red brass which has the inner channel 10 and which permits a substantially parallel orientation of pipe elements which can be connected to the inlet 4 and outlet 6. The device 2 is constructed as a dual-wall plate which has securing means 11, in this instance in the form of a base plate with at least one hole.

There is provided a drain 12 which connects the inner channel 10 to the connection 8 so as to allow flow. In this manner, a pipeline system such as a circulation pipe which extends at the inlet 4 and outlet 6 and partially through the inner channel 10 can be connected so as to allow flow to a tap which is arranged on the connection 8.

The drain 12 has a portion 14 for thermal decoupling. The portion 14 comprises a sleeve 16 which comprises high-grade steel, plastics material and/or ceramic material and which is connected to the remaining drain 12 by means of threads. The threads are additionally secured or sealed by means of Teflon layers 18. As a result of the fact that the portion 14 substantially comprises high-grade steel, plastics material and/or ceramic material, which have a lower thermal conductivity than the material of the remaining drain 12 or the inner channel 10, in this instance, for example, red brass or copper, the inner channel 10 and connection 8 are thermally decoupled. The thermal decoupling is further supported by the Teflon layers 18. The portion 14 has in this instance along the drain 12 a length which at least corresponds to the diameter of the inner channel.

There is consequently produced a significantly lower heat transfer via the material of the device 2 than if, for example, the entire device 2 were to be produced from red brass.

Furthermore, means for decoupling the inner channel 10 and drain 12 in technical flow terms are provided. The device 2 has a curved piece 20 which guides the drain 12 out of a plane in which the inner channel extends. In this instance, the curved piece 20 brings about an angle of over 45° or over 80° between the drain 12 and the plane of the inner channel 10. The curved piece 20 is in this instance arranged between the portion 14 for thermal decoupling and the inner channel 10. As a result of the curved piece 20, in particular together with the inner channel 10 which is constructed as a U-piece, a mixing of the water which flows through the inner channel 10, for example, in a circulation pipe, with the water which is located in the drain 12 is prevented so that a heat transfer between the inner channel and connection 12 is further reduced.

In addition, the drain 12 from the inner channel 10 to the connection 8 has a length which corresponds to at least three times a diameter of the inner channel 10. As a result of this sizing, the inner channel 10 and drain 12 are further decoupled in technical flow terms.

As a result of the portion 14 for thermal decoupling, in particular in combination with the means described for decoupling in technical flow terms, during operation of a tap on the connection 8 the tap is substantially decoupled from a line which extends through the inner channel 10. Consequently, with a hot water pipe a significantly lower heating of the tap occurs and with a cold water pipe a significantly lower cooling of the tap occurs. Consequently, the pipe is protected and hygiene problems can be combatted.

FIG. 2 shows a second embodiment of a device 2 in a perspective. The same reference numerals as in FIG. 1 were used for elements which correspond to each other.

A significant difference with respect to the embodiment from FIG. 1 is the position of the curved piece 20. The curved piece 20 is arranged between the portion 14 for thermal decoupling and the connection 8. Furthermore, the length of the drain from the inner channel to the connection is selected to be larger. This length corresponds in this instance to at least 5 times the diameter of the inner channel 10. The heat transfer between a tap on the connection 8 and a line which extends through the inner channel 10 can thereby be further reduced.

FIG. 3 shows an embodiment of a system 22 as a schematic illustration. A hot water pipe 24 and a cold water pipe 26 which are both constructed as a circulation pipe are connected to a tap 28 by means of a device 2 described above. The tap 28 is constructed as a mixer tap and has a hot water control valve 30 and a cold water control valve 32 which can supply water to an outlet 34.

As a result of the use of the devices 2, the temperature of the tap 28 is substantially decoupled from the temperatures inside the hot water pipe 24 and cold water pipe 26, which both loads the tap 28 to a lesser extent and combats hygiene problems.

In order to demonstrate this effect, attempts were made in which systems shown in FIG. 3 were each operated with the embodiments of the device 2 from FIGS. 1 and 2 with circulation pipes. The outlet 34 was not activated and maintained in this instance until a thermal balance had been produced.

The temperatures shown below in Table 1 were measured in this instance at the points indicated in FIG. 3.

TABLE 1

| Device 2 | T_{K1}(° C.) | T_{K2}(° C.) | T_{W1}(° C.) | T_{W2}(° C.) | T_{A}(° C.) |
|---|---|---|---|---|---|
| FIG. 1 | 25.9 | 32.2 | 58.0 | 49.5 | 30.2 |
| FIG. 2 | 25.9 | 23.0 | 58.0 | 25.6 | 23.0 |

It can be seen that, with the embodiment from FIG. 1, the temperature at the hot water control valve TW2 and at the outlet TA in comparison with the temperature in the hot water pipe TW1 could be reduced. In the same manner, the temperature at the cold water control valve TK2 and at the outlet TA in comparison with the temperature in the cold water pipe TK1 was only slightly increased.

With the embodiment from FIG. 2, it was even possible for the temperatures at the control valves TK2 and TW2 and at the outlet TA to be close to ambient temperature. Consequently, an almost complete decoupling of the tap 28 from the pipes 24, 26 was achieved.

1. A device for connecting at least one tap and a pipe, comprising:
at least one inlet;
at least one outlet;
at least one connection;
an inner channel which connects the inlet and the outlet so as to be able to be flowed through; and
a drain which connects the inner channel to the connection so as to be able to be flowed through,
wherein
the drain has at least one portion for thermal decoupling from the inner channel and connection.

2. The device according to claim 1,
wherein
the portion for thermal decoupling has a lower thermal conductivity than the remaining drain and the inner channel.

3. The device according to claim 1,
w herein
the portion for thermal decoupling comprises at least partially high-grade steel, plastics material, or ceramic material.

4. The device according to claim 1,
wherein
the portion for thermal decoupling along the drain has a length which corresponds to at least half of a diameter of the inner channel.

5. The device according to claim 1,
further comprising
a means for decoupling the inner channel and drain in technical flow terms.

6. The device according to claim 5,
wherein
the means for decoupling in technical flow terms comprises a curved piece which in particular guides the drain out of a plane in which the inner channel extends.

7. The device according to claim 5,
wherein
the drain from the inner channel to the connection has a length which corresponds to at least 3 times a diameter of the inner channel.

8. A system comprising:
at least one device according to claim 1, and
at least one pipe which is connected to the inlet and the outlet and which extends partially through the inner channel.

9. The system according to claim 8,
further comprising
at least one cold water pipe and at least one hot water pipe, wherein
at least one mixing tap for hot water and cold water is connected via the device to the cold water pipe and the hot water pipe.

10. A method of making a water system comprising connecting at least one tap and at least one pipe via the device according to claim 1.

11. The device according to claim 4, wherein the portion for thermal decoupling along the drain has a length which corresponds to at least the diameter of the inner channel.

12. The device according to claim 7, wherein the drain from the inner channel to the connection has a length which corresponds to at least 5 times the diameter of the inner channel.

13. The device according to claim 2, wherein the portion for thermal decoupling comprises at least partially high-grade steel, plastics material, or ceramic material.

14. The device according to claim 2, wherein the portion for thermal decoupling along the drain has a length which corresponds to at least half of a diameter of the inner channel.

15. The device according to claim 3, wherein the portion for thermal decoupling along the drain has a length which corresponds to at least half of a diameter of the inner channel.

16. The system according to claim 8, wherein the portion for thermal decoupling of the at least one device has a lower thermal conductivity than the remaining drain and the inner channel.

17. The system according to claim 8, wherein the portion for thermal decoupling of the at least one device comprises at least partially high-grade steel, plastics material, or ceramic material.

18. The system according to claim 8, wherein the portion for thermal decoupling along the drain of the at least one device has a length which corresponds to at least half of a diameter of the inner channel.

19. The system according to claim 18, wherein the length corresponds to at least the diameter of the inner channel.

20. The system according to claim 8, wherein the at least one device further comprises a means for decoupling the inner channel and drain in technical flow terms.
